(19) United States
(12) Patent Application Publication
(10) Pub. No.: US 2024/0183507 A1
(43) Pub. Date: Jun. 6, 2024

(54) LENS STRUCTURE FOR VEHICLE LAMP

(71) Applicant: HONDA MOTOR CO., LTD., Tokyo (JP)

(72) Inventors: Go SHIMIZU, Tokyo (JP); Shunsuke IWAO, Tokyo (JP); Hiroya OHKUBO, Saitama (JP)

(21) Appl. No.: 18/519,087

(22) Filed: Nov. 27, 2023

(30) Foreign Application Priority Data
Dec. 2, 2022 (CN) 202211540654.4

(51) Int. Cl. F21S 41/265

(52) U.S. Cl. CPC F21S 41/265

(57) ABSTRACT

An object of the present invention is to make it possible to efficiently distribute a light beam that would otherwise be distributed to a lower area to a direct front area and the vicinity thereof. A lens structure for a vehicle lamp includes a light emitting surface 67 at an end in an irradiation direction Y+ and configured to irradiate a light beam in the irradiation direction Y+ from the light emitting surface 67. The light emitting surface 67 includes an optical cut 75 that has a convex shape protruding in the irradiation direction Y+, that has an apex portion 75c at an intermediate portion in the vertical direction, and that is provided asymmetrically in the vertical direction. The optical cut 75 has a flat portion 77 residing from the apex portion 75c to a predetermined position located closer to an upside Z+ than the apex portion 75c, and the flat portion 77 has a smaller curvature than portions 76, 78 adjacent in the vertical direction Z to the flat portion 77.

This application is based on and claims the benefit of priority from Chinese Patent Application No. CN202211540654.4, filed on 2 Dec. 2022, the content of which is incorporated herein by reference.

### BACKGROUND OF THE INVENTION

### Field of the Invention

The present invention relates to a lens structure for a vehicle lamp.

### Related Art

Some lens structures include, on a light emitting surface thereof, a plurality of optical cuts each having the shape of a convex lens or the like, and emit light through the optical cuts while diffusing the light.

### CITATION LIST

### Patent Document

Patent Document 1: Japanese Unexamined Patent Application, Publication No. 2015-115165

### SUMMARY OF THE INVENTION

For a vehicle lamp such as a blinker, a position lamp, and the like, it is not required to distribute a large quantity of light to a lower area, whereas in many cases, it is required to distribute a large quantity of light to a direct front area and the vicinity thereof from the viewpoint of laws and regulations, for example.

However, in such a lens structure, simply upwardly inclining the optical axis direction itself of the optical cut can reduce the light distribution to the lower area, but involves upward shifting of the maximum point of light, thereby making it impossible to efficiently distribute the light to a direct front area and the vicinity thereof. In contrast, if the light can be efficiently distributed to the direct front area and the vicinity thereof, the visibility from the surroundings can be improved, and the traffic safety can be further improved, thereby contributing to the development of the sustainable transportation system.

The present invention has been made in view of the above circumstances, and an object of the present invention is to efficiently distribute light that would otherwise be distributed to a lower area to a direct front area and the vicinity thereof.

The present inventors have achieved the present invention based on their findings that when a predetermined portion of an optical cut is provided with a flat portion having a smaller curvature than portions adjacent in the vertical direction to the flat portion, light that would otherwise be distributed to a lower area can be efficiently distributed to an area such as a direct front area. The present invention relates to a lens structure for a vehicle lamp encompassing the following first to sixth aspects.

A first aspect of the present invention is directed to a lens structure for a vehicle lamp, the lens structure including a light emitting surface at an end in an irradiation direction and being configured to irradiate a light beam in the irradiation direction from the light emitting surface. In a plan view as viewed in an orthogonal direction orthogonal to a vertical direction and the irradiation direction, the light emitting surface includes an optical cut that has a convex shape protruding in the irradiation direction, has an apex at an intermediate portion in the vertical direction, and is provided asymmetrically in the vertical direction. In a plan view as viewed in the orthogonal direction, the optical cut has a flat portion residing from the apex to a predetermined position above the apex, the flat portion having a smaller curvature than portions adjacent in the vertical direction to the flat portion.

Due to this configuration, in which the optical cut is convex, a light beam passing in the irradiation direction through a portion below the apex is inclined upward. On the other hand, due to the flat portion, a light beam passing in the irradiation direction through a portion above the apex is not at all or not significantly inclined downward. Therefore, the light beam that would be distributed to a lower area if there were no flat portion can be distributed to a direct front area and the vicinity thereof. As a result, the light beam that would otherwise be distributed to the lower area can be efficiently distributed to the direct front area and the vicinity thereof.

A second aspect of the present invention is an embodiment of the first aspect. In the lens structure according to the second aspect, the optical cut is symmetrical in the orthogonal direction.

This configuration, in which the optical cut is symmetrical in the orthogonal direction and asymmetrical in the vertical direction, makes it possible to efficiently distribute the light beam to the direct front area and the vicinity thereof, while making the shape of the optical cut as simple as possible.

A third aspect of the present invention is an embodiment of the first or second aspect. In the lens structure according to the third aspect, the optical cut has an upper curved portion above the flat portion and a lower curved portion below the flat portion, and in a plan view as viewed in the orthogonal direction, the upper curved portion has a smaller curvature than the lower curved portion.

Due to this configuration, the inclination of the light beam emitted downward from the upper curved portion is smaller than the inclination of the light beam emitted upward from the lower curved portion. Thus, the light beam that would be distributed to a further lower area if the curvature of the upper curved portion were equal to the curvature of the lower curved portion can be distributed to a direct front area and the vicinity thereof. This feature makes it possible to more efficiently distribute the light beam to the direct front area and the vicinity thereof.

A fourth aspect of the present invention is an embodiment of the first or second aspect. In the lens structure according to the fourth aspect, the light emitting surface includes a plurality of the optical cuts arranged in the vertical direction, and
in a plan view as viewed in the orthogonal direction, a step is formed between the optical cuts arranged in the vertical direction, an upper end of a lower optical cut of the optical cuts protruding in the irradiation direction with respect to a lower end of the upper optical cut of the optical cuts.

If the step were not provided, the portion above the apex of the optical cuts would tend to be longer in the vertical direction than the portion below the apex of the optical cuts, since the portion above the apex of the optical cuts has a smaller curvature than the portion below the apex of the optical cuts. In contrast, the above-described configuration, in which the step is provided, can eliminate such an adverse effect.

A fifth aspect of the present invention is an embodiment of the first or second aspect. In the lens structure according to the fifth aspect, the light emitting surface has a plurality of optical rows being arranged side by side in the orthogonal direction, each of the optical rows including a plurality of the optical cuts arranged in the vertical direction.

This configuration, in which the optical rows extending in the vertical direction are arranged side by side in the orthogonal direction, makes it possible to provide a region in which the optical cuts spread in the vertical direction and the orthogonal direction.

A sixth aspect of the present invention is an embodiment of the fifth aspect. In the lens structure according to the sixth aspect, the plurality of optical rows is shifted from each other in the irradiation direction.

Due to this configuration, since the optical rows are shifted from each other in the irradiation direction, the ends in the irradiation direction of the optical rows that are arranged in the orthogonal direction can be shifted sequentially smoothly in the irradiation direction while the optical axis direction of each optical ridge is oriented in the irradiation direction.

As described above, the first aspect of the present invention makes it possible to efficiently distribute the light beam that would otherwise be distributed to the lower area to the direct front area and the vicinity thereof. The second to sixth aspects as the embodiments of the first aspect exert the respective additional effects.

### BRIEF DESCRIPTION OF THE DRAWINGS

FIG. 1 is a perspective view illustrating a lens structure according to a first embodiment;

FIG. 2 illustrates the lens structure as viewed in the X+ direction;

FIG. 3 illustrates the lens structure as viewed from above;

FIG. 4 illustrates a light emitting surface as viewed in the X+ direction;

FIG. 5 illustrates a light emitting surface of a first comparative example as viewed in the X+ direction;

FIG. 6 illustrates a light emitting surface of an embodiment as viewed in the X+ direction; and

FIG. 7 shows diagrams illustrating light distribution in a second comparative example, light distribution in the first comparative example, and light distribution in the present embodiment.

### DETAILED DESCRIPTION OF THE INVENTION

Embodiments of the present invention will be described below with reference to the drawings. It should be noted that the present invention is not limited to the following embodiments, and can be appropriately modified and implemented without deviating from the spirit of the present invention.

### First Embodiment

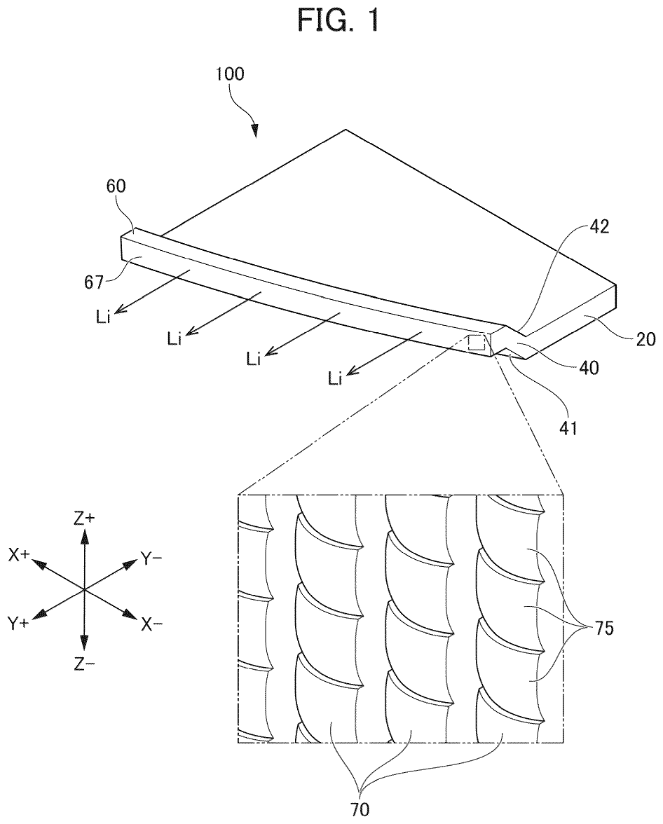

A lens structure 100 illustrated in FIG. 1 is for use as a part of a vehicle lamp, such as a blinker.

In the following, two predetermined horizontal directions that are orthogonal to each other are referred to as an “X direction” and a “Y direction”. In respect of the X direction, the sides opposite to each other are referred to as an “X− side” and an “X+ side”, respectively, and a direction toward the X− side is referred to as a “X− direction” and a direction toward X+ side is referred to as an “X+ direction”. In respect of the Y direction, the sides opposite to each other are referred to as a “Y− side” and a “Y+ side”, respectively, and a direction toward the Y− side is referred to as a “Y− direction” and a direction toward the Y+ side is referred to as a “Y+ direction”. The Y+ direction may be read as an “irradiation direction”. The X direction may be read as an “orthogonal direction”.

As illustrated in FIG. 1, the lens structure 100 includes a base portion 20, an intermediate portion 40, and a leading portion 60. The base portion 20 extends in the X direction and the Y direction. The intermediate portion 40 projects upward from a Y+ side end of the base portion 20, and has a first reflective portion 41 at its lower end and a second reflective portion 42 at its upper end. The leading portion 60 extends in the Y+ direction from the upper end of the intermediate portion 40.

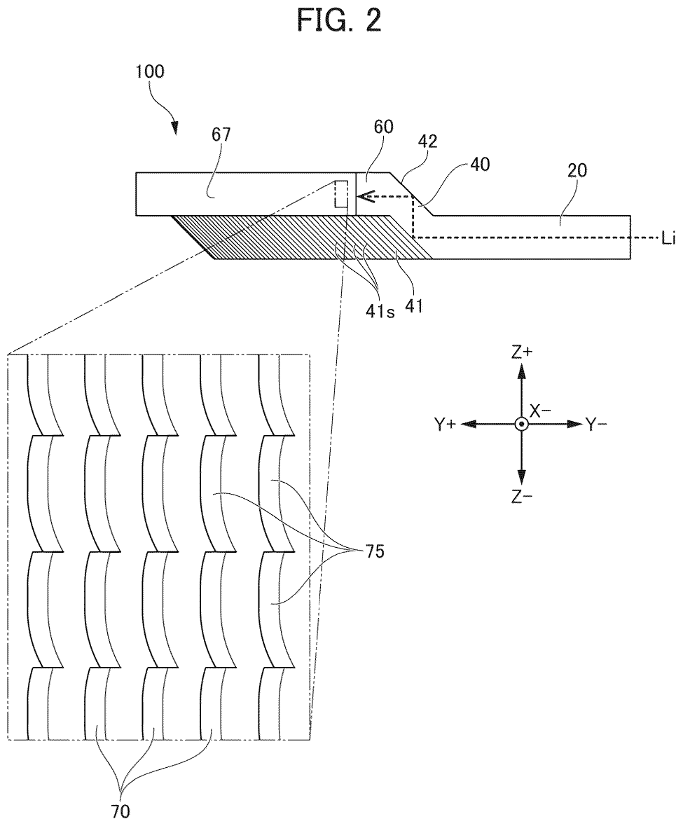

As illustrated in FIG. 2, parallel light beams traveling in the Y+ direction are incident on a Y− side end of the base portion 20. The first reflective portion 41 has a plurality of first reflective surfaces 41s arranged side by side in the X direction while being shifted from each other in the Y direction. Specifically, the closer the first reflective surfaces 41s are positioned to the X+ side, the closer they are positioned to the Y+ side. The first reflective surfaces 41s are arranged such that a direction orthogonal to them is inclined at 45° toward an upside Z+ with respect to the Y− direction, and reflect all the parallel light beams coming from the base portion 20 in the upside Z+. Each first reflective surface 41s may continuously extend in the inclination direction of the first reflective portion 41, or may be divided at intervals in the Y direction.

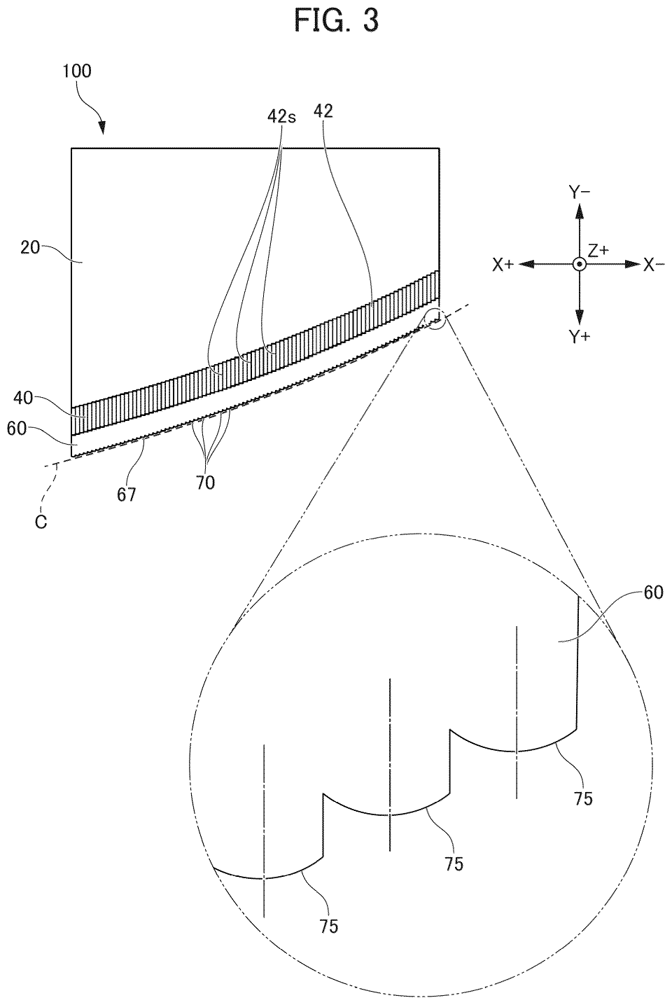

As illustrated in FIG. 3, the second reflective portion 42 has a plurality of second reflective surfaces 42s arranged side by side in the X direction while being shifted from each other in the Y direction. Specifically, the closer the second reflective surfaces 42s are positioned to the X+ side, the closer they are positioned to the Y+ side. The second reflective surfaces 42s are arranged such that a direction orthogonal to them is inclined at 45° toward the Y+ side with respect to the downward direction Z−, and reflect all the light beams Li coming from the first reflective portion 41 in the Y+ direction. Each second reflective surface 42s may continuously extend in the inclination direction of the second reflective portion 42, or may be divided at intervals in the vertical direction Z.

As illustrated in FIG. 1, the leading portion 60 has a light emitting surface 67 at its Y+ side end. The light emitting surface 67 has optical rows 70 arranged side by side in the X direction, each of the optical rows being a row of a plurality of optical cuts 75 arranged in the vertical Z direction. Specifically, the plurality of optical rows 70 arranged in the X direction are shifted from each other in the Y direction.

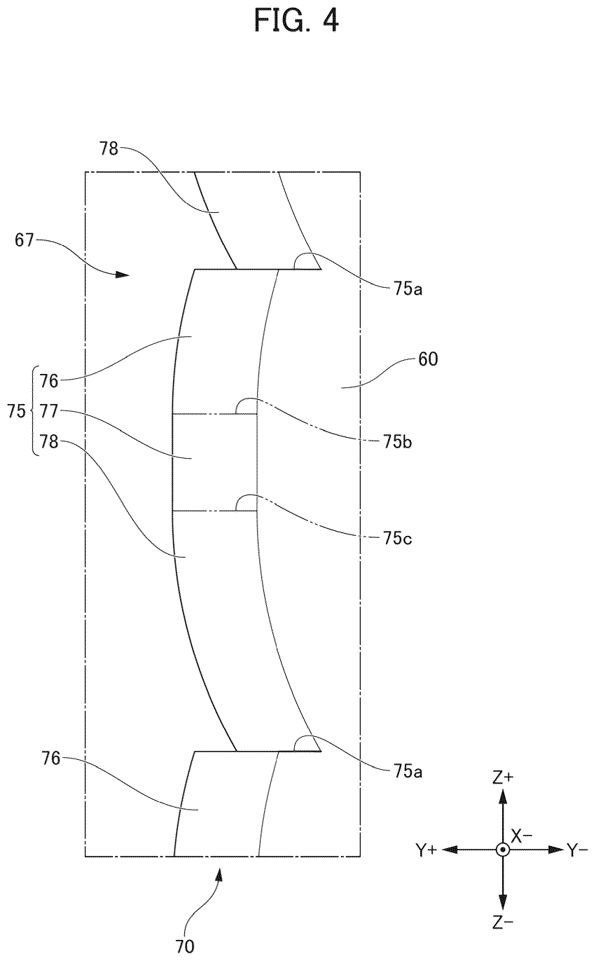

As shown in FIG. 4, each of the optical cuts 75 has the shape of a convex lens of which an intermediate portion in the vertical direction protrudes toward the Y+ side, and has an apex line 75c extending in the X direction at a substantially center portion in the vertical direction Z. Here, the apex line 75c is a set of points protruding most in the Y+ direction at positions along the X direction, in each optical cut 75. The “apex line 75c” may be read as an “apex”.

Each optical cut 75 is symmetrical in the X direction, as illustrated in FIG. 3, but is asymmetrical in the vertical direction Z in a plan view as viewed in the X direction, as illustrated in FIG. 4. Specifically, in a plan view as viewed in the X direction, a portion from the apex line 75c to a predetermined virtual line 75b located closer to the upside Z+ than the apex line 75c on the surface of each optical cut portion 75 constitutes a flat portion 77 having a smaller curvature than portions adjacent in the vertical direction Z. The virtual line 75b as used herein is a line extending in the X direction along the surface of each optical cut 75. The “virtual line 75b” may be read as a “predetermined position”.

In the following description, an area of the optical cut 75 located closer to the upside Z+ than the flat portion 77 is referred to as an “upper curved portion 76”, and an area of the optical cut 75 located closer to the downside Z− than the flat portion 77 is referred to as a “lower curved portion 78”. In a plan view as viewed in the X direction, the upper curved portion 76 has a smaller curvature than the lower curved portion 78, and the flat portion 77 has a smaller curvature than the upper curved portion 76. A step 75a is formed between the optical cuts 75 arranged in the vertical direction Z, an upper end of the optical cuts 75 on the lower side protruding in the Y+ direction with respect to a lower end of the optical cuts 75 on the upper side.

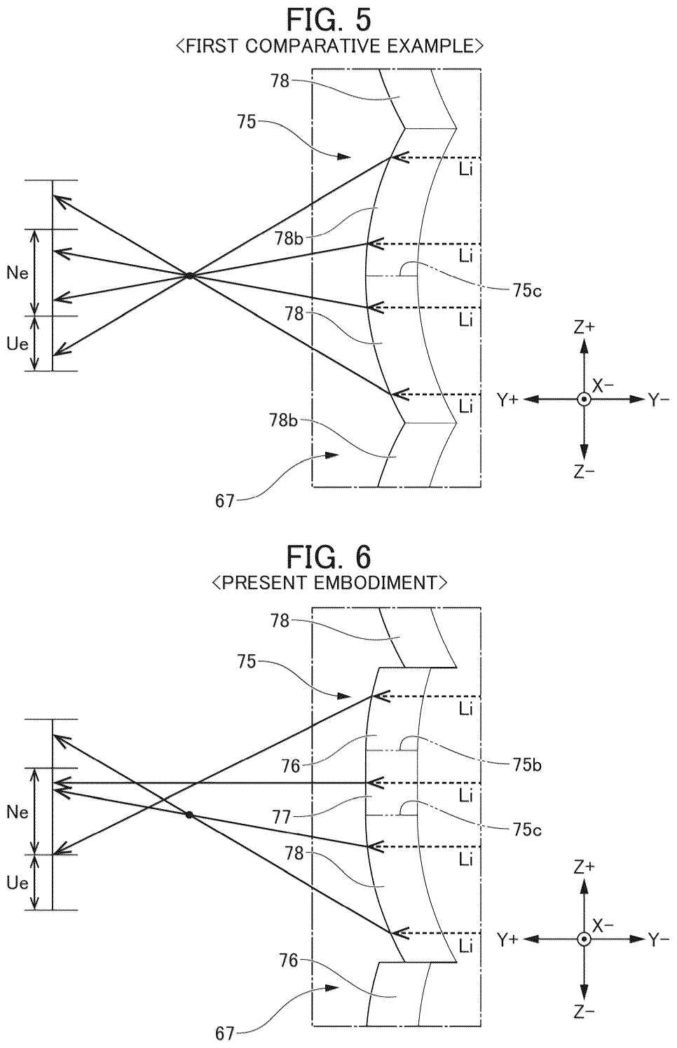

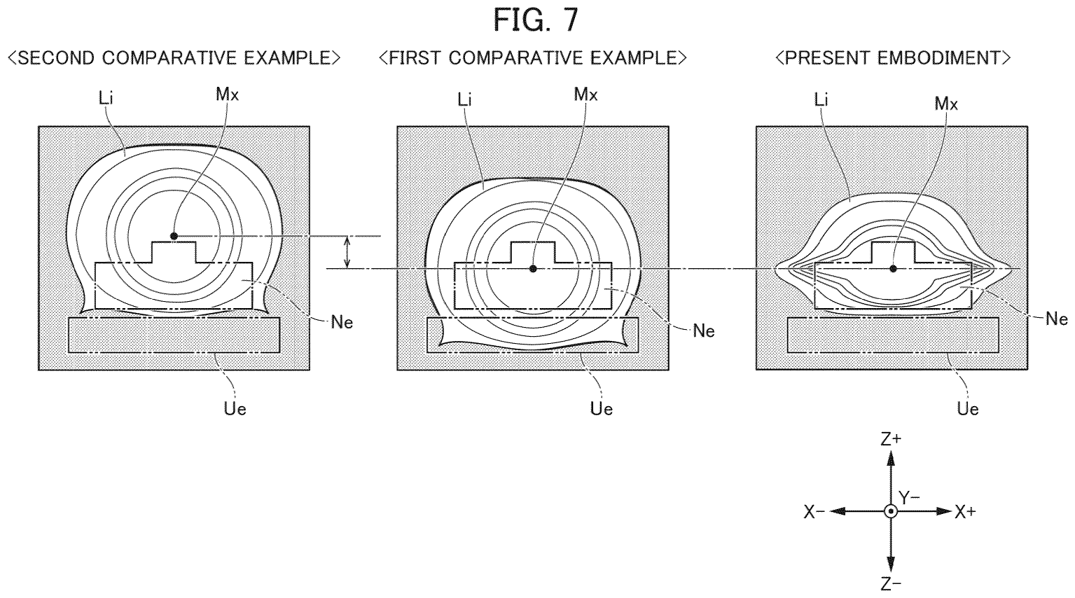

Next, the function of the optical cuts 75 will be described. In the following description, an optical cut 75 illustrated in FIG. 5 is referred to as a first comparative example, which is devoid of the flat portion 77 and the upper curved portion 76, but instead, includes a symmetrical curved portion 78b having the shape of the lower curved portion 78 inverted in the Z direction. In the case of the first comparative example, light beams Li in the Y+ direction that have reached each of the optical cuts 75 from the second reflective portion 42 are substantially symmetrically diffused on both sides in the vertical Z direction. In this case, as illustrated in <FIRST COMPARATIVE EXAMPLE> in FIG. 7, the light beams Li emitted from the light emitting surface 67 illuminate a region that is substantially symmetrical in the vertical Z direction. Here, it is considered that an area close to the downside Z− in the region is a less-light-requiring area Ue that does not require much light distribution, and an area close to the center in the vertical Z direction is a much-light-requiring area Ne that requires much light distribution.

Here, as a measure for distributing the light beams Li that are going to be distributed to the less-light-requiring area Ue to the much-light-requiring area Ne, it is conceivable to shift the optical axis direction itself of the optical cut 75 toward the upside Z+ from the state of the first comparative example illustrated in FIG. 5. In the following description, a configuration in which this measure is taken is referred to as a “second comparative example”.

However, as illustrated in <SECOND COMPARATIVE EXAMPLE> in FIG. 7, this configuration causes the entire region illuminated by the light beams Li emitted from the light emitting surface 67 to be shifted toward the upside Z+, and as a result, a maximum point Mx of the light quantity near the center of the region is also shifted toward the upside Z+. Consequently, even though the light distribution to the less-light-requiring area Ue decreases, the light distribution to the much-light-requiring area Ne also decreases. Thus, it is impossible to distribute the light beams Li directed to the less-light-requiring area Ue to the much-light-requiring area Ne.

In this respect, according to the present embodiment, the optical cut 75 has the flat portion 77 and the upper curved portion 76 each having a smaller curvature than the lower curved portion 78, as illustrated in FIG. 6. The flat portion 77 causes the light beams in the Y+ direction to travel straight in the Y+ direction substantially without refraction. Furthermore, the upper curved portion 76 refracts the light beams less sharply than the lower curved portion 78. As a result, as illustrated in <PRESENT EMBODIMENT> in FIG. 7, the light beams Li that would otherwise be distributed to the less-light-requiring area Ue can be efficiently distributed to the much-light-requiring area Ne without shifting the maximum point Mx toward the upside Z+.

The configuration and effects of the present embodiment are summarized below.

As illustrated in FIG. 6, the light beams passing in the Y+ direction through the lower curved portion 78 of the optical cut 75 are emitted in a direction inclined toward the upside Z+ by convex lens effect. On the other hand, the light beams passing in the Y+ direction through the flat portion 77 above the apex line 75c are emitted in the Y+ direction substantially without inclination. As a result, the light beams Li that would be distributed to an area close to the downside Z− if there were no flat portion 77 can be distributed to a direct front area and the vicinity thereof. This makes it possible to distribute the light beams that would otherwise be distributed to the less-light-requiring area Ue to the much-light-requiring area Ne as illustrated in <PRESENT EMBODIMENT> in FIG. 7.

As illustrated in FIG. 3, each optical cut 75 is symmetrical in the X direction. Making the optical cut 75 symmetrical in the X direction and asymmetrical in the vertical direction Z renders it possible to distribute the light beams that would otherwise be distributed to the less-light-requiring area Ue to the much-light-requiring area Ne while making the shape of the optical cut 75 as simple as possible.

As illustrated in FIG. 6, the curvature of the upper curved portion 76 is smaller than the curvature of the lower curved portion 78 in a plan view as viewed in the X direction. Therefore, the inclination of the light beams Li emitted from the upper curved portion 76 toward the downside Z− is smaller than the inclination of the light beams Li emitted from the lower curved portion 78 toward the upside Z+. Thus, the light beams Li that would be distributed to a further in proximity to the downside Z− if the curvature of the upper curved portion 76 were equal to the curvature of the lower curved portion 78 can be distributed to a direct front area and the vicinity thereof. This feature makes it possible to more efficiently distribute the light beams that would otherwise be distributed to the less-light-requiring area Ue to the much-light-requiring area Ne.

As illustrated in FIG. 4, a step 75a is formed between the optical cuts 75 arranged in the vertical direction Z, an upper end of the optical cuts 75 on the lower side protruding in the Y+ direction with respect to a lower end of the optical cuts 75 on the upper side. This configuration makes it possible to prevent the optical cut 75 from having a large length in the vertical Z direction while the curvatures as described above are maintained.

As illustrated in FIG. 1, on the light emitting surface 67, the optical rows 70 are arranged side by side in the X direction, each of the optical rows 70 including the optical cuts 75 arranged in the X direction, each of optical cuts 75 diffusing light beams Li traveling in the Y+ direction. This configuration makes it possible to provide a region in which the optical cuts 75 spread in the vertical direction Z and the X direction.

As illustrated in FIG. 1, the plurality of optical rows 70 arranged in the X direction are shifted from each other in the Y direction. Due to this configuration, as illustrated in FIG. 3, the Y+ side ends of the optical rows 70 that are arranged in the X direction can be shifted sequentially smoothly in the Y direction along the shape of a curve C while the optical axis direction of each optical ridge 70 is oriented in the Y+ direction.

### EXPLANATION OF REFERENCE NUMERALS

67: Light emitting surface
70: Optical ridge
75: Optical cut
75a: Step
75b: Virtual line (Predetermined position)
75c: Apex line (Apex)
76: Upper curved portion (Portion adjacent in the vertical direction)
77: Flat portion
78: Lower curved portion (Portion adjacent in the vertical direction)
100: Lens structure for a vehicle lamp
Li: Light beam
X: Orthogonal direction
Y: Irradiation direction
Z: Vertical direction
Z+: Upside
Z−: Downside

What is claimed is:

1. A lens structure for a vehicle lamp, the lens structure comprising a light emitting surface at an end in an irradiation direction and being configured to irradiate a light beam in the irradiation direction from the light emitting surface,
in a plan view as viewed in an orthogonal direction orthogonal to a vertical direction and the irradiation direction, the light emitting surface comprising an optical cut that has a convex shape protruding in the irradiation direction, has an apex at an intermediate portion in the vertical direction, and is provided asymmetrically in the vertical direction,
in a plan view as viewed in the orthogonal direction, the optical cut comprising a flat portion residing from the apex to a predetermined position above the apex, the flat portion having a smaller curvature than portions adjacent in the vertical direction to the flat portion.

2. The lens structure according to claim 1, wherein
the optical cut is symmetrical in the orthogonal direction.

3. The lens structure according to claim 1, wherein
the optical cut has an upper curved portion above the flat portion and a lower curved portion below the flat portion, and
in a plan view as viewed in the orthogonal direction, the upper curved portion has a smaller curvature than the lower curved portion.

4. The lens structure according to claim 1, wherein
the light emitting surface comprises a plurality of the optical cuts arranged in the vertical direction, and
in a plan view as viewed in the orthogonal direction, a step is formed between the optical cuts arranged in the vertical direction, an upper end of a lower optical cut of the optical cuts protruding in the irradiation direction with respect to a lower end of an upper optical cut of the optical cuts.

5. The lens structure according to claim 1, wherein
the light emitting surface comprises a plurality of optical rows arranged side by side in the orthogonal direction, each of the optical rows including a plurality of the optical cuts arranged in the vertical direction.

6. The lens structure according to claim 5, wherein
the plurality of optical rows is shifted from each other in the irradiation direction.
